(19) United States
(12) Patent Application Publication
(10) Pub. No.: US 2025/0100354 A1
(43) Pub. Date: Mar. 27, 2025

(54) Vehicle Having a Fragrancing System for Fragrancing a Boarding Region of a Vehicle

(71) Applicant: Bayerische Motoren Werke Aktiengesellschaft, Muenchen (DE)

(72) Inventor: Annabelle COFFINET, Muenchen (DE)

(21) Appl. No.: 18/291,959

(22) PCT Filed: Jun. 5, 2023
(86) PCT No.: PCT/EP2023/064986

§ 371 Date: Jan. 25, 2024

(30) Foreign Application Priority Data
Jun. 29, 2022 (DE) 10 2022 116 158.7

(51) Int. Cl. B60H 3/00; B60J 5/04; B60J 10/86; B60Q 9/00

(52) U.S. Cl. CPC B60H 3/0014; B60J 5/0493

(57) ABSTRACT

A carrier film for fragrancing a boarding region of a vehicle is provided with a fragrance and is designed such that its rear side can be fastened to an inner region of a vehicle door in such a way that the carrier film releases fragrance into the boarding region when the vehicle door is open, and is covered when the vehicle door is closed. The vehicle door is also provided with a carrier film arranged thereon and provided with a fragrance.

### BACKGROUND AND SUMMARY

The invention relates to a fragrancing system for fragrancing a boarding region of a vehicle.

There are already fragrance distributors in vehicles with the focus of disseminating a pleasant fragrance in the vehicle interior. DE 10 2015 110 702 A1 proposes a fragrance carrier which can transfer its fragrance to a fragrance carrier element in the form of an adhesive film. The utility model 90 01 115.5 discloses a self-adhesive fragrance carrier.

However, there is still a need for improvement in the area of fragrancing vehicle boarding regions.

Therefore, an object of this invention is to provide an improved fragrancing system for fragrancing a boarding region of a vehicle. This object is achieved according to the invention by the features of the independent patent claims. The dependent claims relate to advantageous embodiments of the invention.

The invention proposes a vehicle, comprising a vehicle door which has a window frame and a door seal, and a carrier film which is fastened to an inner side of the vehicle door and is intended for fragrancing a boarding region of the vehicle, and a carrier film for fragrancing a boarding region of a vehicle, wherein the carrier film is provided with a fragrance and is designed such that its rear side can be fastened to an inner region of a vehicle door in such a way that the carrier film releases fragrance into the boarding region when the vehicle door is open, and is covered when the door is closed.

In one embodiment, it is provided that the rear side is designed such that it is at least partially adhesive, or such that it can be fastened to a predefined region of the vehicle door by means of static adhesion.

In one embodiment, it is provided that the shape of the carrier film is matched to the shape of the region of the vehicle door to which it is to be fastened.

In one embodiment, it is provided that the carrier film is arranged in an upper region of the vehicle door that faces toward the rear of the vehicle.

In one embodiment, it is provided that the carrier film is arranged on the door seal or in a region between the door seal and the window frame.

In one embodiment, it is provided that the carrier film is arranged in a region of a door inner panel and above a door lock.

In one embodiment, it is provided that the vehicle door is a driver's door.

In one embodiment, it is provided that the vehicle additionally has one or more means configured to optically and/or acoustically indicate the fragrance provided by the carrier film when the vehicle door is being opened, in accordance with predefined criteria.

The invention also provides a vehicle door, to the inner side of which a carrier film provided with a fragrance is fastened.

In one embodiment, it is provided that the vehicle door has a window frame and a door seal, and wherein the carrier film is arranged in an upper region of the vehicle door that faces toward the rear of the vehicle.

In one embodiment, it is provided that the carrier film is arranged on the door seal or in a region between the door seal and the window frame.

In one embodiment, it is provided that the carrier film is arranged in a region of a door inner panel and above a door lock.

In one embodiment, it is provided that the vehicle door is a driver's door.

The invention also provides a vehicle having the vehicle door. In one embodiment, it is provided that the vehicle additionally has one or more means configured to optically and/or acoustically indicate the fragrance provided by the carrier film when the vehicle door is being opened, in accordance with predefined criteria.

Further features and advantages of the invention will emerge from the following description of exemplary embodiments of the invention, on the basis of the figures of the drawing, which shows details according to the invention, and from the claims. The individual features may be realized in each case individually by themselves or as a plurality in any desired combination in a variant of the invention.

Preferred embodiments of the invention will be explained in more detail below on the basis of the appended drawings.

### BRIEF DESCRIPTION OF THE DRAWINGS

FIG. 1 is a schematic illustration of preferred positions for a carrier film on the vehicle door in accordance with embodiments of the invention.

FIG. 2 is a schematic illustration of a positioning of the carrier film on an upper region of the vehicle door according to one embodiment of the present invention.

FIG. 3 is a schematic illustration of a positioning of the carrier film on a door inner panel of the vehicle door according to another embodiment of the present invention.

In the following descriptions of the figures, elements or functions that are the same are provided with the same reference signs.

### DETAILED DESCRIPTION OF THE DRAWINGS

The two proposed fragrancing systems (carrier film 10) serve to fragrance a boarding region of a vehicle when the vehicle door 200 is opened or closed. With particular preference, the driver is intended to experience the fragrance, i.e. the vehicle door 200 is preferably a driver's door, wherein this can be both a driver's door for a right-hand-drive vehicle and a driver's door for a left-hand-drive vehicle (as shown in the figures). In both embodiments, the fragrancing system (carrier film 10) is exposed by the vehicle door 200 by opening the vehicle door 200, so that fragrance molecules can be dispensed into the boarding region.

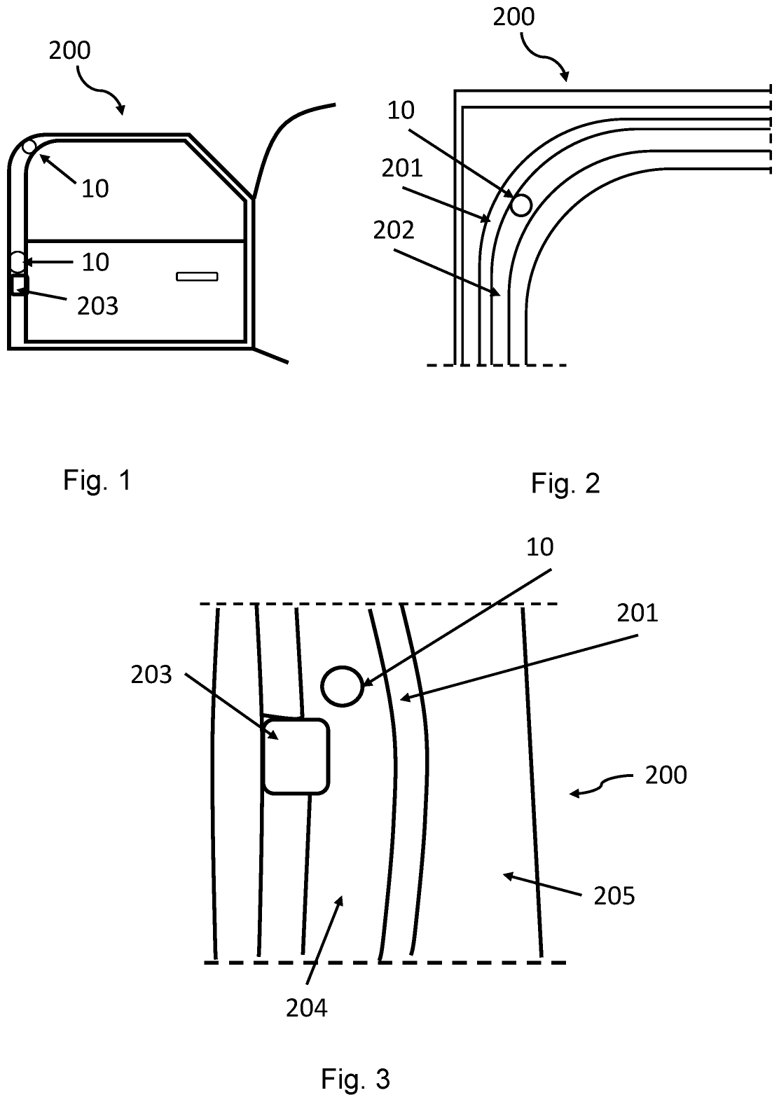

FIG. 1, which shows a view of an inner side of a vehicle door 200, illustrates preferred positions of the carrier film 10, which is provided with a fragrance and will be described in more detail with reference to FIGS. 2 and 3.

The fragrancing system consists of a (very) thin carrier film (10), which is preferably in the form of a polymer film. A fragrance is integrated on one side of the carrier film 10 or in the carrier film 10. This fragrance is continually dispensed, that is to say does not require an activator such as a draft of air or heat. As an alternative, the fragrance may also be created such that it is activated by an air stream which arises owing to the vehicle door 200 being opened and is incident thereon.

An underside of the carrier film 10 is fastened in a region of the vehicle door 200 that faces toward the vehicle interior, for example by means of adhesive bonding over the entire surface area or at certain points, or by means of individual adhesive strips. In one embodiment, it is fastened so as to be removable without residue, for example by means of static adhesion or a suitable adhesive. It may, however, also be clampable or insertable in a fastening device provided in the region of the frame of the vehicle door 200. The type of attachment has only a subordinate role for the fragrancing. What is important is that the carrier film 10 stably adheres for example to a panel of the vehicle door 200 or to the rubber of the door seal 201 and does not detach after repeated opening and closing of the vehicle door 200.

The fastening position of the carrier film 10 is selected on the vehicle door 200 such that it is not visible when the vehicle door 200 is closed and is covered by, for example, a seal or the body frame in such a way that it can no longer dispense fragrance outward, i.e. the fragrance is no longer perceptible.

A preferred fastening position for the carrier film 10 is on an upper region of the vehicle door 200 close to the head of a vehicle occupant and approximately at their eye level, as shown in FIG. 2 (view of the inner side of the vehicle door 200 from inside the vehicle) in an enlarged detail of an upper region of the vehicle door 200. As a result, the fragrance can be very clearly perceived both in the event of boarding and disembarking. The described fastening position may, as is also shown in FIG. 2, be at a transition between an upper region of the vehicle door 200 and a rear region of the vehicle door 200 facing toward the vehicle rear, this substantially corresponding to the eye level for a vehicle occupant.

In the embodiment shown in FIG. 2, the carrier film 10 is arranged in a transition region between the door seal 201 and the window frame 202 and is pressed into the door seal 201 when the vehicle door 200 is being closed. The carrier film 10 is thin enough not to adversely affect the function of the door seal 201.

An alternative or additional fastening position for the carrier film 10 is on a door inner panel 204 of the vehicle door 200, more specifically that part of the door inner panel 204 that is provided in the direction of the inner region of the door seal 201 (reference sign 205 marks the outer part, which is separated from the inner part 204 by the door seal 201) above the (merely schematically illustrated) door lock 203, as shown in FIG. 3. The position can, however, also be varied further upward, that is to say just below the window. In this embodiment, the carrier film 10 is likewise completely covered by a closed vehicle door 200, and is thus not visible when the vehicle door 200 is closed, and fragrance can no longer be dispensed outward, or the fragrance is not perceptible. This embodiment is advantageous in particular when the vehicle door 200 does not have a frame and thus does not have a door seal 201 in the region of the glazing. In this embodiment, too, fragrancing is provided when the vehicle occupant boards and disembarks.

The shape of the carrier film 10 is matched to the respective shape of the vehicle door 200 and the position on the vehicle door 200. It may also be used for other vehicle types. For this, it may be cut to the right size, for example.

The carrier film 10 may be both transparent or matched to the color of the attachment location, so that the user can virtually not perceive it. It may, however, also be provided with a color and/or a pattern or logo in order for the user to perceive it.

It is also possible, for example, to provide an indicator such as a color indicator in order to specify the amount of fragrance, so that the user is provided with information that, for example, they can use the carrier film 10 for a longer period of time or that they must exchange or renew it in order to continue experiencing the fragrance.

The carrier film 10 can comprise different fragrances which the user can select, since the carrier film 10 is exchangeable. Advantageously, it has a fragrance associated with the vehicle brand (signature fragrance), that is to say a fragrance that the user can or should identify with the vehicle brand. As an alternative, however, different fragrances can also be offered. Since the carrier film 10 is exchangeable by removing it or sticking another carrier film over it, the fragrance can thus be exchanged as needed.

The carrier film 10 should preferably be able to dispense fragrance for several months. The precise length of time for which the fragrance can be dispensed depends inter alia on the size of the carrier film 10, the material and its ability to take up and dispense fragrance molecules, and the frequency of use of the vehicle door 200, that is to say how often it is opened and the length of time it stays open.

The use of a carrier film 10 makes it much easier to handle the fragrancing, since for example liquid, which must be introduced into a recess of the vehicle and possibly activated by means of an activator, in flasks or ampules is no longer required. A saving is made on space both in the vehicle and in the case of transporting refills. Moreover, waste is reduced.

The proposed fragrancing system fragrances the door region exclusively when the vehicle door 200 is open, and therefore it is possible to create a welcome and departure scenario. In addition, when the vehicle door 200 is being opened, an optical and/or acoustic indication of the fragrance can be given by corresponding means (lighting, sound output). The opening of the vehicle door 200 is generally detected in any case by at least one controller, which can then also output corresponding signals to the optical and/or acoustic indication means.

### REFERENCE SIGNS

200 Vehicle door
201 Door seal
202 Window frame
203 Door lock
204 Door inner panel inner side of 200
205 Door inner panel outer side of 200
10 Carrier film

1.-8. (canceled)

9. A vehicle, comprising:
a vehicle door which has a window frame and a door seal; and
a carrier film intended for fragrancing a boarding region of the vehicle, wherein
the carrier film is provided with a fragrance and is configured such that a rear side thereof is fastened to an inner region of a vehicle door such that the carrier film releases fragrance into the boarding region when the vehicle door is open, and is covered when the vehicle door is closed.

10. The vehicle according to claim 9, wherein the rear side of the carrier film is:
at least partially adhesive, or
fastenable to a predefined region of the vehicle door by static adhesion.

11. The vehicle according to claim 9, wherein
a shape of the carrier film is matched to a shape of the inner region of the vehicle door to which it is fastened.

12. The vehicle according to claim 9, wherein
the carrier film is arranged in an upper, rear, region of the vehicle door in a longitudinal direction of the vehicle.

13. The vehicle according to claim 12, wherein
the carrier film is arranged on the door seal or in a region between the door seal and the window frame.

14. The vehicle according to claim 9, wherein
the carrier film is arranged on the door seal or in a region between the door seal and the window frame.

15. The vehicle according to claim 9, wherein
the carrier film is arranged in a region of a door inner panel and above a door lock.

16. The vehicle according to claim 9, wherein the vehicle door is a driver's door.

17. The vehicle according to claim 9, further comprising:
means for optically and/or acoustically indicating the fragrance provided by the carrier film when the vehicle door is being opened, in accordance with predefined criteria.
